(19) United States
(12) Patent Application Publication
(10) Pub. No.: US 2025/0327455 A1
(43) Pub. Date: Oct. 23, 2025

(54) FLUID CIRCULATOR FOR HEATING OR COOLING SYSTEMS

(71) Applicant: TACO ITALIA S.R.L., Sandrigo (VI) (IT)

(72) Inventors: Alessio GUERRINI, Bassano del Grappa (VI) (IT); Daniele SARTOR, San Martino di Lupari (PD) (IT)

(73) Assignee: TACO ITALIA S.R.L., Sandrigo (VI) (IT)

(21) Appl. No.: 19/259,721

(22) Filed: Jul. 3, 2025

Related U.S. Application Data
(63) Continuation of application No. 18/081,678, filed on Dec. 14, 2022, now Pat. No. 12,352,270.

(30) Foreign Application Priority Data
Dec. 14, 2021 (IT) 102021000031277

(51) Int. Cl. F04D 13/06; F04D 29/42; H02K 3/02; H02K 3/44; H02K 3/50; H02K 5/22

(52) U.S. Cl. CPC F04D 13/0693; F04D 29/4286; H02K 3/02; H02K 3/44; H02K 3/50; H02K 5/225; H02K 2203/06

(57) ABSTRACT

An electric motor for a fluid circulator. The electric motor includes a plastic portion and a stator with an electrical winding made of aluminum or aluminum alloys. The electric motor includes a connecting element made of a material that is not aluminum or aluminum alloys. The connecting element is in contact with the electrical winding of the stator forming an electrical connection between the connecting element and the electrical winding. The electric motor also includes an overmolding of plastic material integral with the plastic portion. The overmolding of plastic material sealingly encloses the at least one electrical connection.

### CROSS-REFERENCE TO RELATED APPLICATIONS

This application is a continuation of U.S. application Ser. No. 18/081,678, filed Dec. 14, 2022, which claims priority to Italian App. No. 102021000031277, filed Dec. 14, 2021, the disclosures of which are hereby incorporated by reference herein.

### TECHNICAL FIELD

The present disclosure relates to a fluid circulator, in particular to a fluid circulator for heating or cooling systems, and to a related heating or cooling apparatus incorporating at least one fluid circulator.

In general, the present disclosure finds application in the field of pumps for moving fluids, wherein an impeller is coupled to and set in motion by an electric motor.

### BACKGROUND

Centrifugal electric pumps, generally known as “circulators”, may be used for the vector fluid circulation in the context of heating and/or cooling systems.

A circulator generally comprises a synchronous electric motor, whose rotor may be keyed on a shaft coupled to an impeller of a pump, which is therefore driven by the electric motor itself and which supplies head to the fluid. Traditional circulators may have different configurations for the impeller, based on the fluid handled and the head to be supplied. For instance, some configurations may provide for an impeller with curved blades, of the centrifugal type, however other configurations of impeller blades may be used.

Circulators are frequently used in heating and/or cooling systems, in particular within heating or cooling apparatuses, such as boilers, heat pumps or others, constituting the functional elements thereof.

### SUMMARY

The solution idea underlying the present disclosure is to make a fluid circulator that overcomes the oxidation and redox problem of the electrical connection between aluminium wire of the winding and power supply terminal (usually made of copper), proposing not only electrical insulation but the overall protection of the surrounding area.

Based on this solution idea, the technical problem is solved by a fluid circulator for heating or cooling systems comprising a pump body having an impeller for fluid handling; an electric motor for rotating the impeller, the electric motor comprising at least one electrical winding; at least one terminal of an electric power supply wiring of the electric motor; at least one electrical connection between the terminal and an end of the at least one electrical winding. The at least one electrical winding is made of aluminium or alloys thereof, and a protection element configured to sealingly enclose the at least one electrical connection is provided.

Advantageously, in the fluid circulator aluminium and alloys thereof are effectively adopted for making the electrical windings of the electric motor.

Advantageously, the fluid circulator is reliably adapted to operate even in aggressive environments where the electrical connection, e.g., usually between Aluminum and Copper conductors, otherwise would be subject to deterioration.

Advantageously, in the fluid circulator good and durable electrical contact in the area of the electrical connection is ensured by the proper protection element.

Advantageously, in the fluid circulator there is an electrical connection stable over time, thus improving the duration of the service life of the circulator.

In short, the fluid circulator motor of this disclosure represents a technical solution having particular effectiveness for application or use in fluid circulators.

Preferably, the protection element adopted in the fluid circulator of this disclosure comprises an over-molding of plastic material applied to the at least one electrical connection. In particular, the manufacturing technique consists in injecting a plastic cover onto the terminal, eliminating the air around the components in the area of the electrical connection.

Preferably, the over-molding covers the at least one electrical connection and the possible interstices thereof, however leaving the other terminations visible and accessible for a PCB insertion.

In a preferred embodiment, the over-molding is made integrally with a further plastic portion of the electric motor, with the advantage of an integrated and more effective and efficient production, or manufacturing, process.

Further features and advantages will become clearer from the following detailed description of a preferred non-limiting embodiment of the present disclosure and from the dependent claims which depict preferred and particularly advantageous embodiments of the disclosure.

### BRIEF DESCRIPTION OF THE DRAWINGS

The disclosure is illustrated with reference to the following figures, given by way of non-limiting example, in which:

FIG. 1 shows a perspective view of a non-limiting example of fluid circulator.

FIG. 2 shows a top view of an embodiment of an electric motor of a fluid circulator according to the present disclosure.

FIG. 3 exemplifies an over-molding of the electric motor of FIG. 2

FIG. 4 shows a perspective view of the electric motor of FIG. 2, in which section IV-IV is visible.

FIG. 5 shows an over-molding process of an electrical connection relating to section IV-IV.

In the several figures, analogous elements will be identified by analogous reference numbers.

### DETAILED DESCRIPTION

In some embodiments, the present disclosure provides a circulator in which it may be possible to effectively adopt aluminum and alloys thereof for making the electrical windings of the electric motor.

In some embodiments, the present disclosure may provide a circulator with electric windings of aluminum and alloys thereof that may be adapted to reliably operate in aggressive environments from an electrochemical point of view, for instance under humid and/or salinity conditions.

In some embodiments, the present disclosure may provide a circulator in which the electrical contact between aluminum wire of the winding and power supply terminal pin may be ensured.

In some embodiments, the present disclosure may provide a circulator in which said electric contact may be stable over time and during the service life of the circulator.

Indeed, said electrical contact between different materials (usually, aluminum and copper) is subject to redox problems, which degrade the electrical contact until it is reduced, thus reducing the service life of the circulator itself.

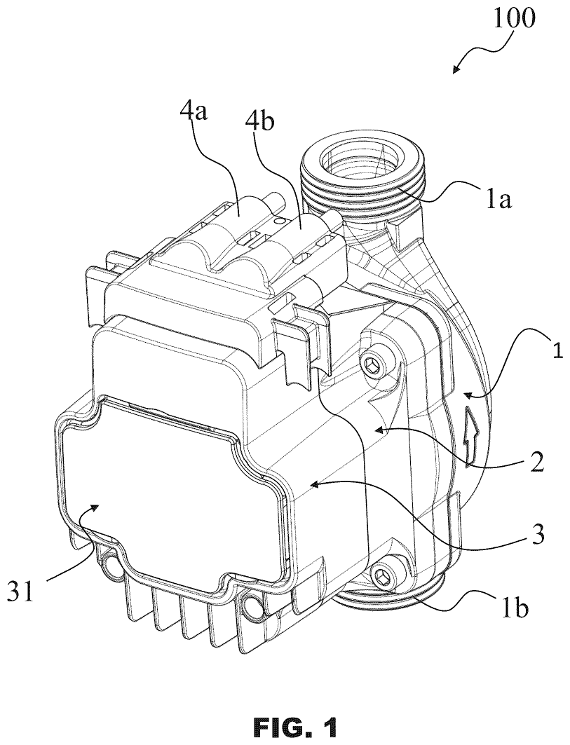

FIG. 1 shows a perspective view of a fluid circulator 100 for heating or cooling systems, which represents a non-limiting example of the present disclosure. The fluid circulator 100 may also be defined as an electric pump, intended for fluid handling in heating and/or cooling systems.

In its general configuration, the circulator 100 may comprise a pump body 1 and an electric motor 2, associated with each other to make the fluid handling.

The pump body 1 may comprise an impeller (not visible) therein which may be rotated by the electric motor 2. In general, the impeller may be housed in a containment volute, which encloses it in the pump body 1 and inside which there is the fluid during the operation of the circulator.

The pump body 1 may comprise an outlet connection 1a and an inlet connection 1b, for the fluid connection to a piping system, which the fluid circulator 100 is connected to and inside which the fluid to be handled flows. Both at the inlet and at the outlet, the connections 1a and 1b may be of the threaded flange or bayonet/plug type.

The electric motor 2 may be of the synchronous type, and may be understood essentially from the following components (not visible in FIG. 1): a permanent magnet rotor and a stator with the related electrical windings. The stator may be of the four stator-arm type, a configuration often used for two-phase electric motors, but other configurations may also be adoptable, for instance a three-phase electric motor configuration. The rotor may be housed within a protective sleeve that may be integrally formed with a flange facing a wall of the volute in which the impeller rotates. The electric motor 2 further comprises a shaft (not visible) of the electric motor, to which the rotor may be keyed and kinematically coupled.

The impeller, which may be of the centrifugal type, may be coupled to and rotated by the shaft, and may be adapted to impart a thrust to the fluid to provide a head or a pressure increase to the same.

In general, the electric motor 2 and the pump body 1 may be separated from each other by a plurality of suitable sealed separating elements, so as to make a waterproof motor body and a watertight volute, thus avoiding fluid leakage.

The fluid circulator 100 may further comprise a terminal box 3 associated with the electric motor 2. Said terminal box 3 may be positioned opposite the pump body 1.

The terminal box 3 may comprise a closing and protection cap 31 for a control electronic card (not visible) of the fluid circulator 100.

The electronic card may be arranged to control the operation of the fluid circulator 100, in particular to control the power supply of the electric motor 2.

The control electronic card may be housed in a containment space defined and limited by the cap 31 when it is fitted and mounted on the terminal box 3.

The circulator 1 may further comprise a plurality of connectors 4a and 4b of the electric or electronic type, which may be connected to the electronic card contained in the terminal box 3.

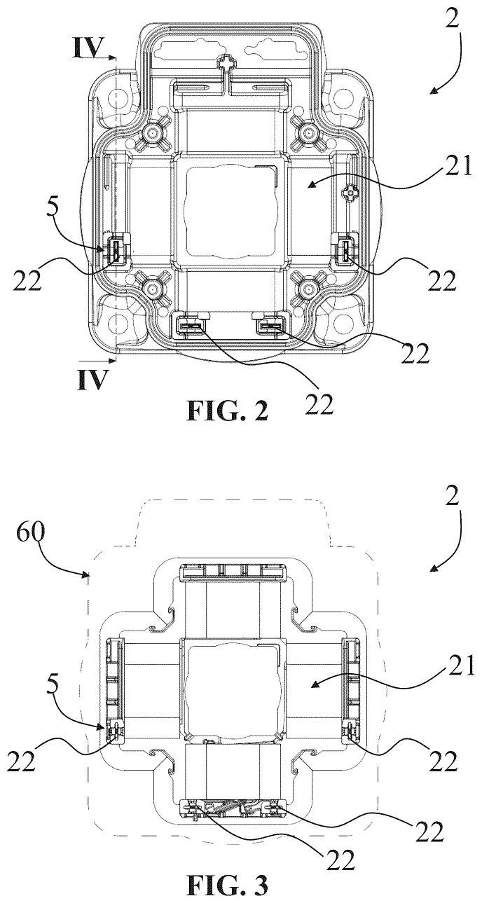

FIG. 2 shows a top view of a part of the electric motor 2. In this view, the stator of the electric motor is visible, but the rotor has been removed for ease of vision.

The electric motor 2 comprises at least one electric winding 21, which is not represented in its entirety showing each individual coil, for a graphical simplification.

In this example, the electric winding 21 is the one of the stator of the electric motor. The disclosure, in a variant, may be adopted in an electric winding of a rotor.

The fluid circulator 100 may further comprise at least one terminal 22 of an electric power supply wiring of the electric motor 2, and at least one electric connection 5 between the terminal 22 and an end of the at least one electric winding 21.

FIG. 3 exemplifies an over-molding 60 of the electric motor 2, corresponding to a semi-finished product compared to what is shown in FIG. 2.

Indeed, the electric winding 21 of the electric motor 2 may be made of aluminum or alloys thereof. The adoption of aluminum or alloys thereof for the electric winding 21 may be due to a reduction of the costs and/or to having an alternative material to use in case of a copper shortage, which the windings of electric motors are traditionally made of.

The aluminum, compared to copper, has a lower electrical conductivity therefore, despite the specific weight of aluminum being still lower, the volume required for a winding of the same power is higher. For this reason it is possible, in a non-limiting manner for the present solution, to keep a compact size of the fluid circulator 100 by appropriately limiting the power of the aluminum winding 21 and by filling all of the respective slots available in the electric motor 2. From an effectiveness point of view of the electric motor 2 with winding made of aluminum or alloys thereof, it is comparable with that of an electric motor with copper winding.

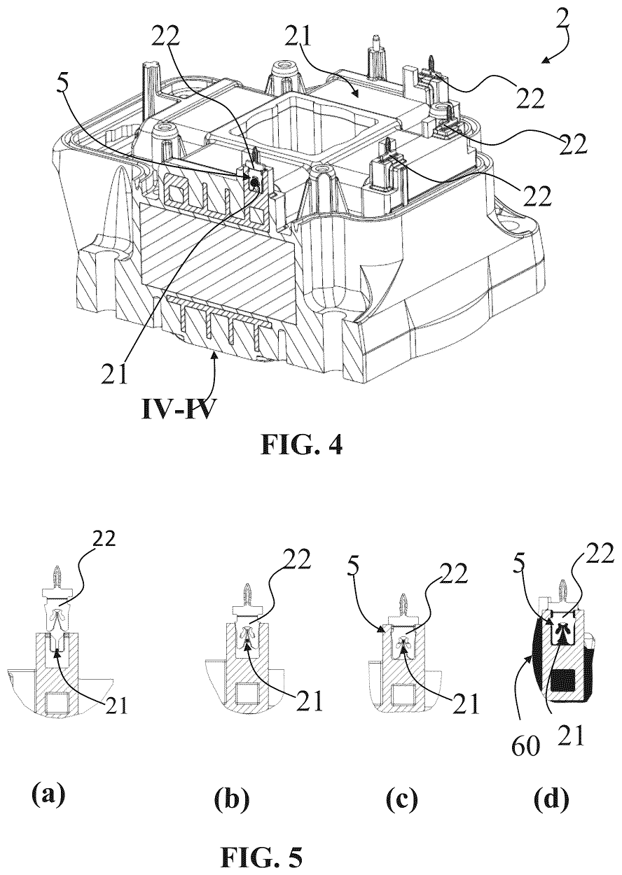

As it will be detailed hereinafter, one aspect in the fluid circulator 100 is to manage to ensure a contact between aluminum wire and electric terminal that is effective and stable over time. FIG. 4 shows a perspective view of the electric motor of FIG. 2, in which section IV-IV is visible, whereon one of the terminals 22 lies and in which the electric connection 5 between the terminal 22 and an end of the at least one electric winding 21 occurs.

To prevent oxidation of the at least one electric connection 5, the fluid circulator 100 may comprise a protection element configured to sealingly enclose said at least one electric connection 5. In particular, the terminal 22 comprises a connecting element made of different material than the winding 21 (made of aluminum or alloys thereof), such as a connecting element 22 made of copper or alloys thereof, preferably coated with tin.

In some embodiments, the connecting element 22 may be of the insulator-indentation type, as it will be further described. An insulator-indentation connector allows indenting the winding insulation and creating an electric contact without any type of welding or crimping of a third component. In some embodiments, the connecting element 22 may be based on a spring principle being it a connector of elastic and resilient material adapted to couple with a respective element (in this case, the wire of the winding 21) and to maintain a stable electric contact exerting a positive mechanical contact force, even on elements of different diameters.

In some embodiments, such as for larger constructions of fluid circulators, the connecting element may be of the “faston” type. In some embodiments, the electric connection may directly provide for a mechanical crimping or welding, with the copper cable of the at least one terminal, namely without necessarily providing for a connecting element.

FIG. 5 shows an over-molding process of an electric connection 5 relating to section IV-IV. With reference to sub-Figure (a), the connecting element 22 may be inserted into the related slot in which the wire of the winding 21 of aluminum or alloys thereof is contained.

With reference to sub-Figure (b), the connecting element 22 may come into contact with the wire of the winding 21 of aluminum or alloys thereof.

With reference to sub-Figure (c), the connecting element 22 of the insulator-indentation type may exert a positive mechanical contact force thus making the electric connection 5.

With reference to sub-Figure (d), the protection element 60, which may be configured to sealingly enclose the electric connection 5, is made. In this example, the protection element comprises an over-molding 60 of plastic material, already schematized in its entirety in FIG. 3. As visible, the over-molding 60 may be applied to the electric connection 5, covering it and also covering any interstices, for a maximum protection and seal of the area. As mentioned, the over-molding 60 may be integrally made with a further plastic portion of the electric motor 2.

In some embodiments, the protection element could comprise a protective coating, such as a resin or a gel (for instance silicone based) or a paint, applied to an area of the at least one electric connection 5. This alternative solution may prevent or reduce the oxidation of the area.

In some embodiments, the protection element may comprise at least one cap element, adapted to respectively seal the electric connection 5. Such embodiments may constitute a limited protection to the area of the electrical terminal. For instance, the cap element may be fixed by interference or by welding (ultrasonic welding for instance).

In general, in some embodiments, the protection element may be adapted to eliminate the exposure of aluminum wire and terminal, e.g., of copper, to oxygen, to limit the oxidation of the pieces, so as to not compromise the reliability of the electrical connection over time.

Even though not represented in the figures, the present disclosure also provides for a related heating or cooling apparatus comprising at least one fluid circulator 100. The heating apparatus may be for instance a boiler or a heat pump, or in general a heat generating device for systems. The cooling apparatus may be for instance an underfloor conditioning or cooling system. The heating or cooling apparatus is a technical solution having particular effectiveness of use, incorporating the at least one circulator 100 whose electric connection with the winding of aluminum or alloys thereof is protected by the protection element adopted according to the present disclosure.

Considering the herein reported description, the person skilled in the art may conceive further changes and variants, in order to meet contingent and specific needs.

The embodiments herein described are therefore to be intended as illustrative and non-limiting examples of the disclosure.

1-14. (canceled)

15. An electric motor for a fluid circulator, the electric motor comprising:
a plastic portion;
a stator with an electrical winding made of aluminum or aluminum alloys;
a connecting element made of a material that is not aluminum or aluminum alloys, the connecting element in contact with the electrical winding of the stator forming an electrical connection between the connecting element and the electrical winding; and
an overmolding of plastic material integral with the plastic portion, wherein the overmolding of plastic material sealingly encloses the at least one electrical connection.

16. The electric motor of claim 15, wherein the overmolding of plastic material covers all interstices of the electrical connection.

17. The electric motor of claim 15, a portion of the connecting element is accessible an configured to be connected to a printed circuit board (PCB).

18. The electric motor of claim 15, wherein the connecting element is made of copper or a copper alloy.

19. The electric motor of claim 18, wherein the connecting element is further coated with tin.

20. The electric motor of claim 15, wherein the connecting element is an insulator-indentation type connecting element.

21. The electric motor of claim 15, wherein the electrical connection is formed by at least one of a mechanical crimping or a welding with the connecting element.

22. The electric motor of claim 15, wherein the overmolding of plastic material is configured to prevent an oxidation of the electrical connection.

23. A fluid circulator comprising:
an electric motor including at least one electrical winding made of aluminum or aluminum alloys;
a pump body connected to the electric motor, wherein the electric motor is configured to rotate an impeller housed within the pump body;
at least one connecting element disposed on the electric motor and made of a material that is not aluminum or aluminum alloys, the at least one connecting element in contact with the at least one electrical winding of the electric motor so as to form at least one electrical connection between the at least one connecting element and the at least one electrical winding; and
an overmolding of plastic material integrally made with a portion of the electric motor, wherein the overmolding of plastic material sealingly encloses the at least one electrical connection.

24. The fluid circulator of claim 23, wherein the overmolding of plastic material covers all interstices of the electrical connection.

25. The fluid circulator of claim 23, wherein a portion of the connecting element is accessible an configured to be connected to a printed circuit board (PCB).

26. The fluid circulator of claim 23, wherein the connecting element is made of copper or a copper alloy.

27. The fluid circulator of claim 26, wherein the connecting element is further coated with tin.

28. The fluid circulator of claim 23, wherein the connecting element is an insulator-indentation type connecting element.

29. The electric motor of claim 23, wherein the electrical connection is formed by at least one of a mechanical crimping or a welding with the connecting element.

30. The electric motor of claim 23, wherein the overmolding of plastic material is configured to prevent an oxidation of the electrical connection

31. A fluid circulator comprising:
an electric motor including a stator with a least one electrical winding made of aluminum or aluminum alloys;
at least one terminal disposed on the electric motor, wherein an end of the at least one electrical winding is disposed within a slot of each terminal of the at least one terminal;
at least one connecting element made of a material other than aluminum or aluminum alloys, wherein the at least one connecting element is disposed within the slot of each terminal of the at least one terminal such that the connecting element contacts the end of the at least one electrical winding forming at least one electrical connection between the at least one connecting element and the end of the at least one electrical winding; and
an overmolding of plastic material integrally made with a portion of the electric motor, wherein the overmolding of plastic material sealingly encloses the at least one electrical connection.

32. The fluid circulator of claim 31, wherein the overmolding of plastic material covers all interstices of the at least one electrical connection.

33. The fluid circulator of claim 31, wherein the at least one electrical connection is made of copper or copper alloy.

34. The fluid circulator of claim 31, wherein the overmolding of plastic material fills the slot of each terminal of the at least one terminal.
